(19) United States
(12) Patent Application Publication
(10) Pub. No.: US 2007/0083574 A1
(43) Pub. Date: Apr. 12, 2007

(54) Replica database maintenance with parallel log file transfers

(75) Inventors: Benedicto E. Garin JR., Hudson, NH (US); Robert R. McGuirk, Nashua, NH (US); Mahesh Girkar, Cupertino, CA (US)

Correspondence Address: MCDONALD HOPKINS CO., LPA, 600 SUPERIOR AVE., E., SUITE 2100, CLEVELAND, OH, 44114, US

(73) Assignee: ORACLE INTERNATIONAL CORPORATION, REDWOOD SHORES, CA (US)

(21) Appl. No.: 11/261,221

(22) Filed: Oct. 28, 2005

Related U.S. Application Data
(60) Provisional application No. 60/724,461, filed on Oct. 7, 2005.

(51) Int. Cl. G06F 17/30

(52) U.S. Cl. 707/204

(57) ABSTRACT

Systems, methods, and other embodiments associated with remote database maintenance using parallel file transfers are described. One exemplary system includes a processor configured to run a database management system (DBMS) that is in turn configured to manage a database (DB). The DBMS may maintain a database log file that stores information about changes to the database. The system may also include a connection logic for establishing data transfer connections between the computing system and a remote computing system storing the database replica. The system may also include a partition logic that separates the database log file into multiple portions and a distribution logic that provides the multiple file portions in parallel to the remote computing system through the multiple data transfer connections.

### BACKGROUND

Databases continue to grow in size and complexity. Databases also continue to be more widely distributed and replicated. The combination of increasing size and increasing replication creates issues concerning maintaining replicas. For example, keeping a replica database current with an original database may require transferring large amounts of data from the original database to the replica. When more than one replica is involved, these data transfers can become burdensome and can threaten to destroy availability.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a database maintenance system.

FIG. 2 illustrates another database maintenance system.

FIG. 3 illustrates a method for maintaining a replica database using parallel log file transfers.

FIG. 4 illustrates another method for maintaining a replica database using parallel log file transfers.

FIG. 5 illustrates an application programming interface associated with maintaining a replica database using parallel log file transfers.

FIG. 6 illustrates an example computing environment in which example systems and methods illustrated herein can operate.

FIG. 7 illustrates an example client-server system for maintaining a remote replica of a database using parallel log file transfers.

FIG. 8 illustrates an example client-server method for maintaining a remote replica of a database using parallel log file transfers.

### DETAILED DESCRIPTION

Example systems and methods described herein concern efficiently facilitating replica database maintenance using parallel log file transfers. Over time a database may be updated by various writes. Maintaining on a remote computer a replica of a database that is being written to may include providing information concerning the writes to the remote computer. In some examples, sets of writes may be organized into a log file and provided collectively to the remote computer rather than providing individual writes. As databases continue to grow, these log files may also become large (e.g., 500 megabytes).

Conventionally, log files may have been provided to a remote computer using a serial file transfer. For example, each of the 500 megabytes of data would be read in turn and provided in turn over a single data communication connection. As database log files continue to grow, this conventional approach may limit the ability to keep a replica database current (e.g., synchronized) with a replicated database. Thus, parallel file transfers facilitate keeping the replica database current. For example, a database log file may be split into several smaller parts and each of these parts may be provided to a remote computer over different data communication connections. In one example, the number of parts into which the log file is split may be determined by the number of connections available between the host computer and the remote computer. In another example, attributes like the number of parts into which the log file is split, the size of the parts into which the file is split, and over which connections a part will be sent may be determined by the characteristics of the connections available between the host computer and the remote computer.

Alternatively and/or additionally, the number and type of connections may be controlled, at least in part, by the size of the log file and/or a priority for updating the replica database. For example, a pool of processes and data connections may be available for remote replica maintenance. A very large (e.g., one gigabyte) log file may acquire several (e.g., ten) high speed connections between a host computer and a remote computer to transfer the file in parallel. A smaller (e.g., five hundred megabyte) log file may acquire fewer (e.g., three) high speed connections and two slow speed connections between a host computer and a remote computer. A small (e.g., fifty megabyte) log file may acquire fewer still (e.g., two) slow speed connections.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, semiconductor memories, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.” Thus, in one example, a computer-readable medium has a form of signals that represent the software/firmware as it is downloaded from a server. In another example, the computer-readable medium has a form of the software/firmware as it is maintained on a server. Other forms may also be used.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic (e.g., application specific integrated circuit (ASIC), analog circuit, digital circuit, programmed logic device), a memory device containing instructions, and so on. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms including routines, algorithms, modules, methods, threads, and/or programs including separate applications or code from dynamically linked libraries. Software may also be implemented in a variety of executable and/or loadable forms including, but not limited to, a stand-alone program, an object, a function (local and/or remote), a servelet, an applet, instructions stored in a memory, part of an operating system or other types of executable instructions. It will be appreciated by one of ordinary skill in the art that the form of software may depend, for example, on requirements of a desired application, on the environment in which it runs, and/or on the desires of a designer/programmer. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein may be fabricated from programming languages and tools including Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, calculating, determining, displaying, and so on, refer to actions and processes of a computer system, logic, processor, or similar electronic device that manipulates and transforms data represented as physical (electronic) quantities.

“User”, as used herein, includes but is not limited to one or more persons, software, computers or other devices, or combinations of these.

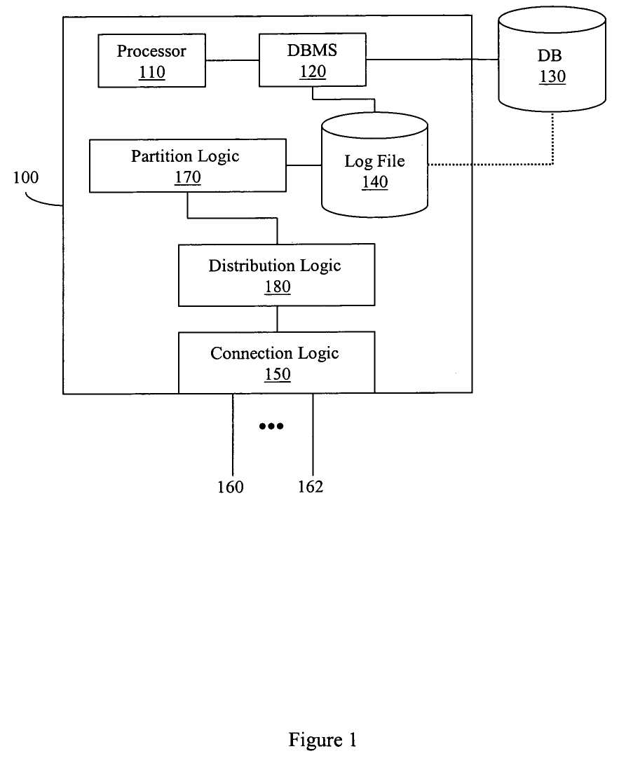

FIG. 1 illustrates a database maintenance system 100. System 100 may include a processor 110 that is configured to run a database management system (DBMS) 120. DBMS 120 may in turn be configured to manage a database (DB) 130. While a single processor 110 is illustrated, it is to be appreciated that system 100 may include multiple processors. Since DB 130 may be updated (e.g., written to), a log file 140 may be maintained to record information about these updates. Log file 140 may store, for example, information concerning writes that have been posted to DB 130, writes that are pending in DB 130, and so on. A posted write is a write that has been completed by a database. System 100 may run on a host computer that stores the database that is replicated by other computers. This database may be referred to as the “replicated database”.

System 100 may also include a connection logic 150. Connection logic 150 may be configured to establish a data transfer connection(s) between system 100 and a remote computing system associated with a replica of DB 130. The connection logic may open multiple data transfer connections (e.g., 160 through 162). The data transfer connections may be, for example, computer network connections. In different examples the data transfer connections may be direct and/or indirect connections that flow directly from system 100 to a remote system or that flow indirectly through one or more intermediate machines between system 100 and a remote system.

In one example, connection logic 150 may be configured to acquire data transfer connection parameters associated with the data transfer connections. These data transfer connection parameters may include, for example, information concerning connection speed, connection type, connection reliability, and so on. In one example, connection logic 150 may be configured to determine the number of data transfer connections to establish between system 100 and a remote system(s) based on the size of the DB log file 140, and/or a priority for updating a replica DB.

System 100 may also include a partition logic 170. Partition logic 170 may be configured to separate DB log file 140 into multiple portions. The number of portions may depend, at least in part, on the number of data transfer connections established by connection logic 150. For example, if connection logic 150 is able to open ten connections, then DB log file 140 may be broken into ten portions, twenty portions, or other numbers of portions. The number of portions may depend not only on the number of connections available, but also on connection attributes including speed, reliability, number of hops, and so on.

System 100 may also include a distribution logic 180. Distribution logic 180 may be configured to provide log file portions in parallel through multiple data transfer connections to a remote computing system(s). In one example, distribution logic 180 may be configured to select the number of parts into which DB log file 140 will be partitioned based, at least in part, on the data transfer connection parameters. For example, if a large number of high and low speed connections are available, then DB log file 140 may be broken into a large number of unequal parts. However, if a small number of high speed connections are available, then DB log file 140 may be broken into a smaller number of equal-sized parts.

In another example, distribution logic 180 may be configured to select a data transfer connection over which to provide a portion of DB log file 140 based, at least in part, on the data transfer connection parameters. For example, if DB log file 140 was broken into unequal parts then a first larger part may be provided through a high speed connection while a second smaller part may be provided through a low speed connection. Thus, by selectively breaking the database log file 140 into unequal parts based on available connections, transmission time may be reduced and/or minimized.

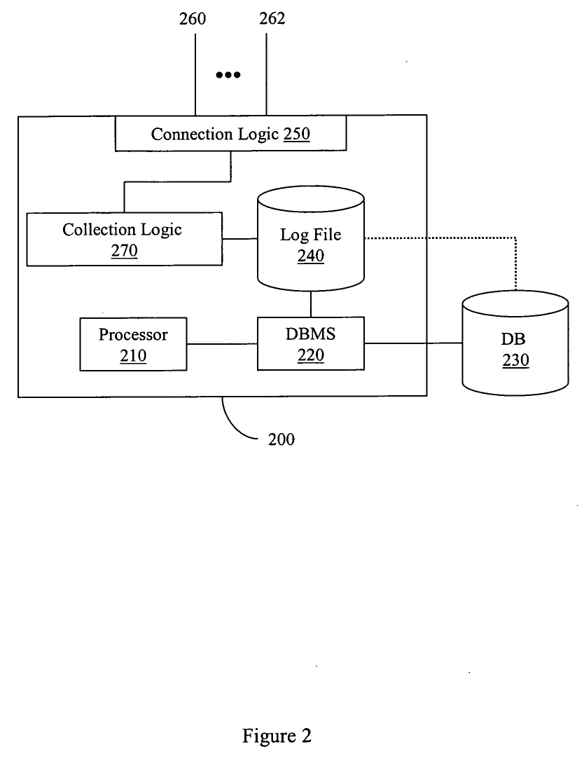

FIG. 2 illustrates a database maintenance system 200. System 200 may run, for example, on a client system tasked with maintaining a replica database 230. System 200 may include a processor 210 that is configured to run a DBMS 220 that is in turn configured to manage the replica DB 230. While a single processor 210 is illustrated, it is to be appreciated that system 200 may include multiple processors. DBMS 220 may be configured to employ a DB log file 240 that is associated with a replicated DB. In different examples DB log file 240 may include a set of writes posted to the replicated DB and/or a set of writes pending to the replicated DB. The replicated DB may be managed, for example, at a host system like that described in FIG. 1. Thus, system 200 may facilitate keeping replica DB 230 current with the replicated DB.

System 200 may also include a connection logic 250 configured to establish data transfer (e.g., computer network) connections (e.g., 260 through 262) between computing system 200 and a host computing system(s) on which the replicated database is managed. Connection logic 250 may allocate a set of processes to manage and/or interact with the connections. In some examples the connections may have different characteristics and thus may receive data at different rates.

System 200 may also include a collection logic 270 that is configured to receive in parallel portions of a DB log file from the host computing system through the connections (e.g., 260 through 262). In one example, collection logic 270 may assemble the portions of the received DB log file into a single remote DB log file 240. As described above, “in parallel” may have different meanings based on available hardware and/or software. By way of illustration, where system 200 has only a single processor 210, then “in parallel” may mean “substantially in parallel” as constrained by the presence of a single processor. However, where system 200 has multiple processors 210 and/or parallel processing available to collection logic 270 and/or connection logic 250, then “in parallel” may mean “in parallel”, rather than “substantially in parallel” as constrained by a single chokepoint.

In one example, collection logic 270 may be configured to selectively insert a received portion of a DB log file into remote DB log file 240. Thus, in the example, log file 240 may be updated in parts rather than serially from start to finish as is conventional. This may facilitate more immediately updating a desired portion and/or a critical portion of log file 240 while other portions may wait. By way of illustration, a “critical portion” of a host log file may arrive as a small file part via a very high speed connection and be posted to log file 240 as soon as possible. In the illustrated example, a less critical portion of the host log file may arrive as a set of larger file parts via slower speed connections and be posted to log file 240 at later points in time.

System 200 may also include a verification logic that is configured to determine whether a received portion of a DB log file has been received correctly. If the verification logic determines that there has been a transmission and/or reception error, then the verification logic may selectively request retransmission of a received portion of the DB log file from the host computing system.

Example methods may be better appreciated with reference to flow diagrams. While for purposes of simplicity of explanation, the illustrated methods are shown and described as a series of blocks, it is to be appreciated that the methods are not limited by the order of the blocks, as some blocks can occur in different orders and/or concurrently with other blocks from that shown and described. Moreover, less than all the illustrated blocks may be required to implement an example method. Blocks may be combined or separated into multiple components. Furthermore, additional and/or alternative methods can employ additional, not illustrated blocks. While the figures illustrate various actions occurring in serial, it is to be appreciated that in different examples various actions could occur concurrently, substantially in parallel, and/or at substantially different points in time.

The illustrated elements denote “processing blocks” that may be implemented in logic. In one example, the processing blocks may represent executable instructions that cause a computer, processor, and/or logic device to respond, to perform an action(s), to change states, and/or to make decisions. Thus, the described methods can be implemented as processor executable instructions and/or operations provided by a computer-readable medium. In another example, the processing blocks may represent functions and/or actions performed by functionally equivalent circuits including an analog circuit, a digital signal processor circuit, an application specific integrated circuit (ASIC), or other logic device.

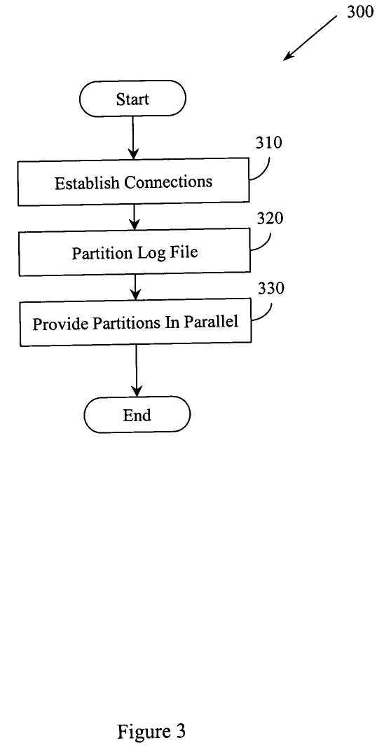

FIG. 3 illustrates a method 300 for maintaining a replica database using parallel log file transfers. A log file may include data concerning changes that have been made to a replicated database. These changes may be the results of writes to the replicated database. Thus, the log file may include a set of posted writes associated with the replicated database, a set of pending writes associated with the replicated database, and so on.

Method 300 may include, at 310, establishing connections between a first computing system and a second computing system. The connections may be, for example, computer network connections that facilitate data transfer. The connections may be direct connections, indirect connections, dedicated connections, shared connections, and so on. The first computing system may be a “host” computing system that maintains a first copy of a database. This first copy may be referred to as the replicated database because it is the database that gets replicated. The second computing system may be a “remote” computing system that maintains a replica copy of the database. This copy may be referred to as the replica copy or the replica since it is a copy of the replicated database.

Method 300 may also include, at 320, partitioning a log file on the first computing system into multiple file parts based, at least in part, on the number of connections established between the first computing system and the second computing system. In one example, the log file may be split into unequal file parts based on connection attributes. For example, if different connections have different predicted speeds and/or reliability, file part sizes may be tailored to the speeds and/or reliability to facilitate minimizing overall, transmission time.

Method 300 may also include, at 330, providing the file parts from the first computing system to the second computing system substantially in parallel. As described above, if multiple processors are available to run method 300, then “substantially in parallel” may equal “in parallel”, while if there is only a single processor or other chokepoint, “substantially in parallel” may mean parallel as constrained by the chokepoint.

While FIG. 3 illustrates various actions occurring in serial, it is to be appreciated that various actions illustrated in FIG. 3 could occur substantially in parallel. By way of illustration, a first process could establish connections, a second process could partition the log file, and a third set of processes could provide the parts of the log file in parallel to a remote computer. While three processes are described, it is to be appreciated that a greater and/or lesser number of processes could be employed and that lightweight processes, regular processes, threads, and other approaches could be employed.

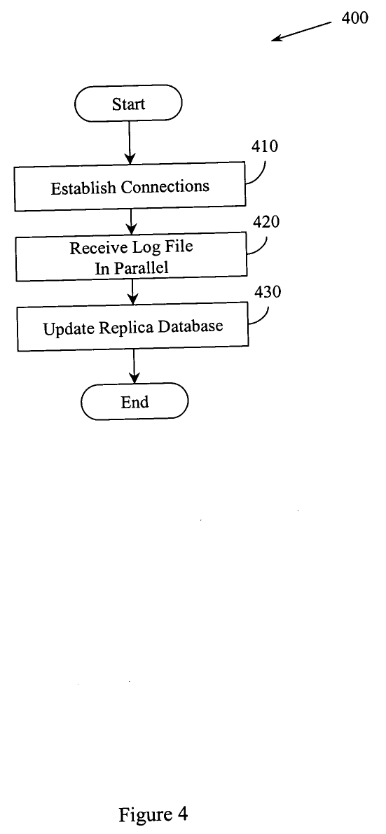

FIG. 4 illustrates a method 400 for maintaining a replica database using parallel log file transfers. The log file may be, for example, a “concurrency file” and/or “synchronization file” that includes information concerning updates to a replicated database. The information may include, for example, a set of posted writes associated with the replicated database, and/or a set of pending writes associated with the replicated database.

Method 400 may include, at 410, establishing connections between a first computing system and a second computing system. The first computing system may be a “host” system configured to maintain a first (e.g., replicated) copy of a database. The second computing system may be a “remote” system configured to maintain a second (e.g., replica) copy of the replicated database. The “host” system may sometimes be referred to as a server system while the “remote” system may sometimes be referred to as a client system.

Method 400 may also include, at 420, receiving parts of a log file substantially in parallel. The parts may be received in the second computing system from the first computing system. The degree of parallelism with which the parts of the log file are received may depend, for example, on the number of connections employed between the computing systems and the hardware and/or software available on the receiving system.

Method 400 may also include, at 430, selectively updating the replica copy of the database based on the received parts of the log file. Thus, the replica copy may be kept up to date with the replicated database. Updating the replica copy may include, for example, changing data stored in the replica copy, deleting data stored in the replica copy, moving data stored in the replica copy, and so on.

While FIG. 4 illustrates various actions occurring in serial, it is to be appreciated that various actions illustrated in FIG. 4 could occur substantially in parallel. By way of illustration, a first process could establish connections, a second set of processes could receive in parallel various portions of a log file, and a third process could update the database replica. While three processes are described, it is to be appreciated that a greater and/or lesser number of processes could be employed and that lightweight processes, regular processes, threads, and other approaches could be employed.

In one example, methods are implemented as processor executable instructions and/or operations stored on a computer-readable medium. Thus, in one example, a computer-readable medium may store processor executable instructions operable to perform a method that includes establishing connections between a first computing system and a second computing system where the first computing system maintains a first copy of a database and the second computing system maintains a replica copy of the database. The method may also include partitioning a log file on the first computing system into multiple parts. The number of parts may depend, at least in part, on the number of connections established between the first computing system and the second computing system. The method may also include providing the file parts from the first computing system to the second computing system substantially in parallel. “Substantially in parallel” refers to the fact that while multiple data connections may be available between machines and while multiple processes may be available to transmit and/or receive the file parts, ultimately, a single processor may be employed to create a single file from the multiple parts. In an example where a transmitting system and/or receiving system includes multiple processors configured to simultaneously transmit, receive, and/or assemble a file from multiple parts, then “substantially in parallel” will be equal to “in parallel”. While the above method is described being stored on a computer-readable medium, it is to be appreciated that other example methods described herein can also be stored on a computer-readable medium.

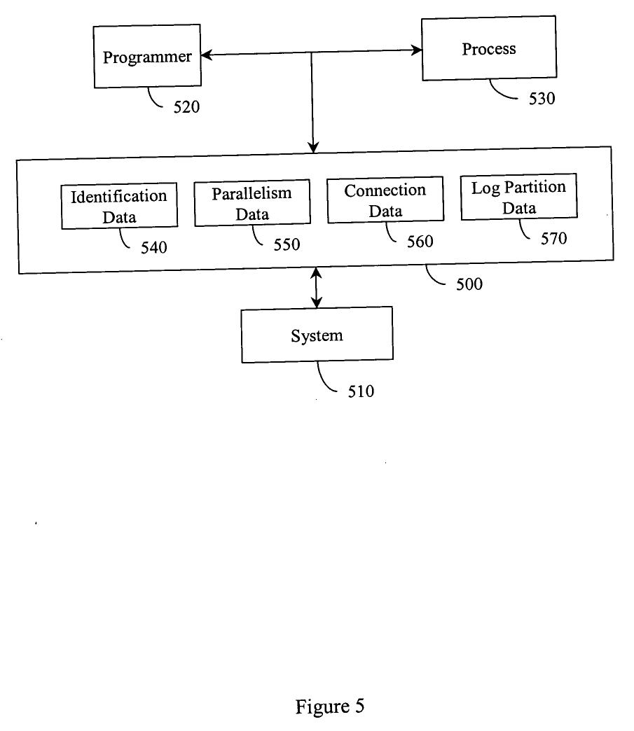

FIG. 5 illustrates an application programming interface (API) 500 that provides access to a system 510 for maintaining a replica database using parallel file transfers. API 500 can be employed, for example, by a programmer 520 and/or a process 530 to gain access to processing performed by system 510. For example, programmer 520 can write a program to access system 510 (e.g., invoke its operation, monitor its operation, control its operation) where writing the program is facilitated by the presence of API 500. Rather than programmer 520 having to understand the internals of system 510, programmer 520 merely has to learn the interface to system 510. This facilitates encapsulating the functionality of system 510 while exposing that functionality.

API 500 may facilitate providing data values to system 510 and/or may facilitate retrieving data values from system 510. For example, a process 530 that processes connection parameters can provide connection data to system 510 via API 500 by using a call provided in API 500.

In one example, an API 500 can be stored on a computer-readable medium. Interfaces in API 500 can include, but are not limited to, a first interface 540 that communicates an identification data, a second interface 550 that communicates a parallelism data, a third interface 560 that communicates a connection data, and a fourth interface 570 that communicates a log partition data. The identification data may describe a log file. For example, the identification data may include a file identifier, a file name, a file size, a file type, and so on. The parallelism data may describe the number and/or type of connections a user wants employed to transfer the file. The connection data may describe, for example, the number of connections available between a host computer and a remote computer, the speed of the connections, the reliability of the connections, and so on. The log partition data may describe, for example, the number of portions into which a log file has been partitioned, portion sizes, and so on.

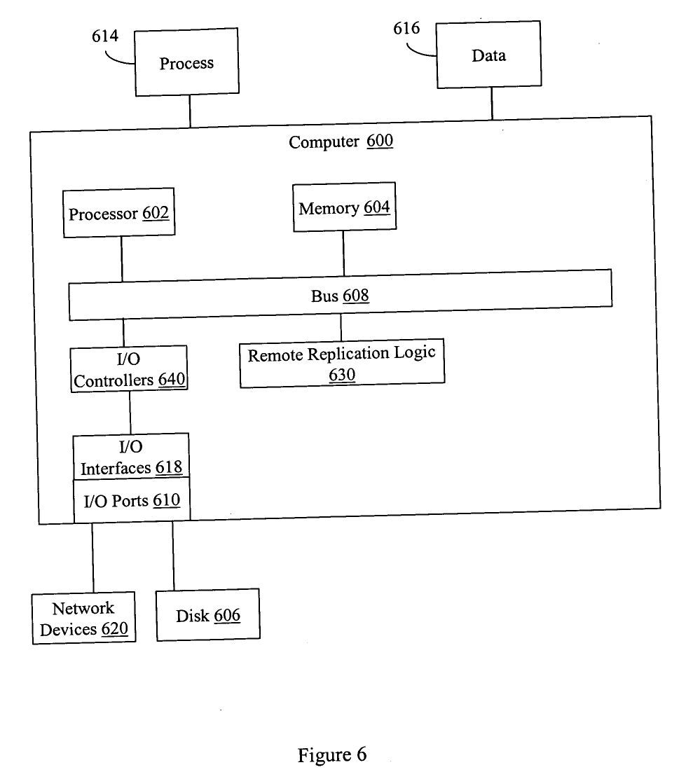

FIG. 6 illustrates an example computing device in which example systems and methods described herein, and equivalents, can operate. The example computing device may be a computer 600 that includes a processor 602, a memory 604, and input/output ports 610 operably connected by a bus 608. In one example, computer 600 may include a remote replication logic 630 configured to facilitate maintaining a remote replica of a database using parallel file transfers. While remote replication logic 630 is illustrated as a hardware component operably connected to bus 608, it is to be appreciated that in one example remote replication logic 630 may be implemented as software stored on disk 606, brought into memory 604 as a process 614, and executed by processor 602.

Remote replication logic 630 may provide means (e.g., hardware, software, firmware) for partitioning a log file, means (e.g., hardware, software, firmware) for establishing connections between computing systems, and means (e.g., hardware, software, firmware) for transmitting, in parallel, a partitioned log file.

Generally describing an example configuration of computer 600, processor 602 can be a variety of various processors including dual microprocessor and other multi-processor architectures. Memory 604 can include volatile memory and/or non-volatile memory. The non-volatile memory can include, but is not limited to, ROM, PROM, EPROM, EEPROM, and so on. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

Disk 606 may be operably connected to computer 600 via, for example, an input/output interface (e.g., card, device) 618 and an input/output port 610. Disk 606 can include, but is not limited to, devices like a magnetic disk drive, a solid state disk drive, a floppy disk drive, a tape drive, a Zip drive, a flash memory card, and/or a memory stick. Furthermore, disk 606 can include optical drives like a CD-ROM, a CD recordable drive (CD-R drive), a CD rewriteable drive (CD-RW drive), and/or a digital video ROM drive (DVD ROM). Memory 604 can store processes 614 and/or data 616, for example. Disk 606 and/or memory 604 can store an operating system that controls and allocates resources of computer 600.

Bus 608 can be a single internal bus interconnect architecture and/or other bus or mesh architectures. While a single bus is illustrated, it is to be appreciated that computer 600 may communicate with various devices, logics, and peripherals using other busses that are not illustrated (e.g., PCIE, SATA, Infiniband, 1394, USB, Ethernet). Bus 608 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

Computer 600 may interact with input/output devices via i/o interfaces 618 and input/output ports 610. Input/output devices can include, but are not limited to, a keyboard, a microphone, a pointing and selection device, cameras, video cards, displays, disk 606, network devices 620, and so on. Input/output ports 610 can include but are not limited to, serial ports, parallel ports, and USB ports.

Computer 600 can operate in a network environment and thus may be connected to network devices 620 via the i/o devices 618, and/or the i/o ports 610. Through network devices 620, computer 600 may interact with a network. Through the network, computer 600 may be logically connected to remote computers. The remote computer(s) may store a replica(s) of a database managed by a DMBS running on computer 600. The networks with which computer 600 may interact include, but are not limited to, a local area network (LAN), a wide area network (WAN), and other networks. Network devices 620 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and so on. Similarly, network devices 620 can connect to WAN technologies including, but not limited to, point to point links, circuit switching networks (e.g., integrated services digital networks (ISDN)), packet switching networks, and digital subscriber lines (DSL).

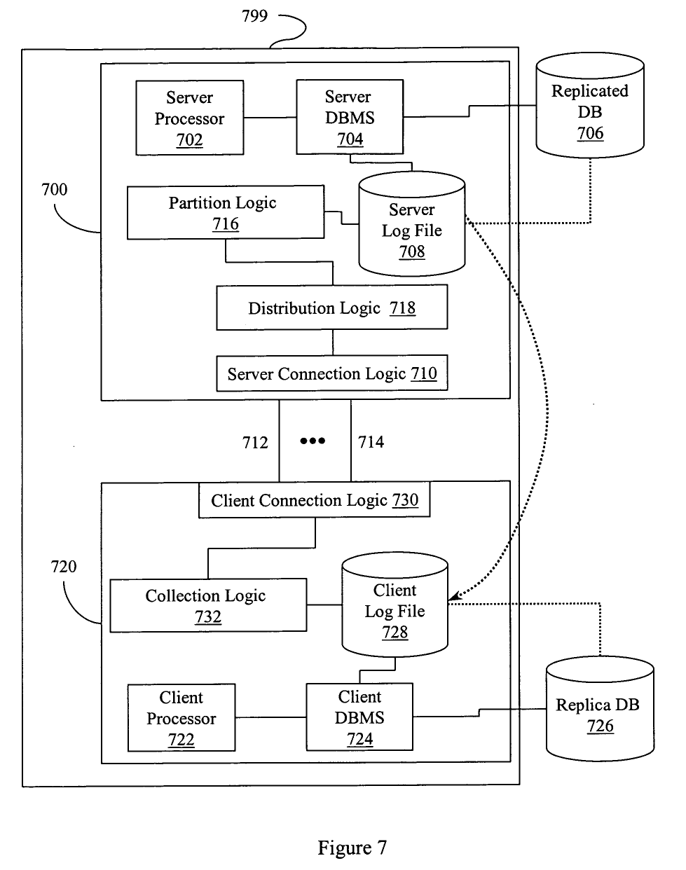

FIG. 7 illustrates an example client-server system 799 for maintaining a remote replica of a database using parallel log file transfers. System 799 may include a server system 700. Server system 700 may include a server processor 702 that runs a server DBMS 704. Server DBMS 704 may manage a replicated database 706. Server DBMS 704 may maintain a server database log file 708 associated with replicated database 706. Log file 708 may store information concerning updates (e.g., writes) to database 706.

System 700 may include a server connection logic 710 for establishing the server side of data transfer connections (e.g., 712 through 714) between server computing system 700 and a client computing system 720. The connections may be, for example, computer networking connections.

System 700 may also include a partition logic 716 for separating server database log file 708 into multiple portions. In one example, the number of parts into which log file 708 is split will be determined by the number of data transfer connections established by server connection logic 710.

System 700 may also include a distribution logic 718 for providing the portions to the client computing system 720 in parallel. The portions may be provided through the data transfer connections established by server connection logic 710.

System 799 may also include a client computing system 720. Client computing system 720 may include a client processor 722 that runs a client DBMS 724 that maintains a replica 726 of database 706. Client DBMS 724 may use a client database log file 728 that corresponds to server database log file 708. Log file 728 may facilitate keeping replica database 726 current with replicated database 706. For example, information concerning updates to replicated database 706 may be stored in log file 708 and provided in parallel to system 720 through connections 712 through 714. System 720 may also include a client connection logic 730 for establishing the client side of connections 712 through 714.

System 720 may also include a collection logic 732 for receiving in parallel the portions of database log file 708 provided in parallel from server system 700 through connections 712 through 714. Collection logic 732 may receive the portions, assemble them into log file 728, and signal client processor 722 that DBMS 724 can update replica database 726 from log file 728.

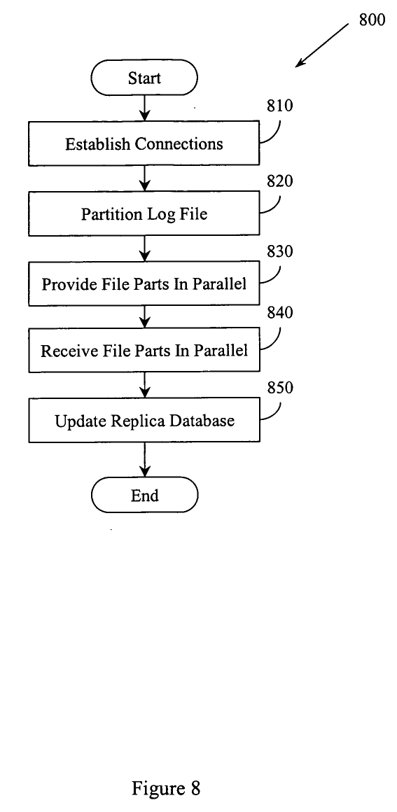

FIG. 8 illustrates an example client-server method 800 for maintaining a remote replica of a database using parallel log file transfers. Method 800 may include, at 810, establishing connections between a server computing system and a client computing system. The server computing system may manage a server copy of a database and the client computing system may manage a client copy of the server database. Method 800 facilitates keeping these two copies synchronized.

Method 800 may include, at 820, partitioning a log file on the server computing system into two or more file parts. How the log file is partitioned may depend, for example, on the number of connections established between the server computing system and the client computing system. For example, if five connections are established then the log file may be split into five parts, ten parts, or a different number of parts.

Method 800 may also include, at 830, providing the file parts from the server computing system to the client computing system substantially in parallel. Method 800 may also include, at 840, receiving substantially in parallel in the client computing system from the server computing system the file parts. The degree of parallelism—actual parallelism versus pseudo parallelism—may depend on the type of hardware and/or software available at one and/or both ends of the communication. With the file parts available, method 800 may then proceed, at 850, with selectively updating the client copy of the server database.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methods for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computing system, comprising:
a processor configured to run a database management system (DBMS) configured to manage a database (DB), the DBMS being configured to maintain a DB log file associated with the DB;
a connection logic configured to establish two or more data transfer connections between the computing system and a remote computing system associated with a replica of the DB;
a partition logic configured to separate the DB log file into two or more portions, the number of portions being determined, at least in part, by the number of data transfer connections established by the connection logic; and
a distribution logic configured to provide the two or more log file portions in parallel to the remote computing system through the two or more data transfer connections.

2. The system of claim 1, the DB log file comprising one or more of, a set of writes posted to the DB, and a set of writes pending to the DB.

3. The system of claim 1, the connection logic being configured to determine the number of data transfer connections to establish based, at least in part, on one or more of, the size of the DB log file, and a priority for updating a replica DB.

4. The system of claim 1, the connection logic being configured to acquire one or more data transfer connection parameters associated with the two or more data transfer connections, the data transfer connection parameters including one or more of, connection speed, connection type, and connection reliability.

5. The system of claim 4, the partition logic being configured to partition the DB log file into two or more unequal sized portions based, at least in part, on the data transfer connection parameters.

6. The system of claim 5, the distribution logic being configured to select the number of partitions into which the DB log will be partitioned based, at least in part, on the data transfer connection parameters.

7. The system of claim 6, the distribution logic being configured to select a data transfer connection over which to provide a portion of the DB log file based, at least in part, on the data transfer connection parameters.

8. A computing system, comprising:
a processor configured to run a DBMS configured to manage a replica DB, the DBMS being configured to employ a DB log file associated with a replicated DB to facilitate keeping the replica DB current with the replicated DB;
a connection logic configured to establish two or more data transfer connections between the computing system and a host computing system associated with the replicated DB; and
a collection logic configured to receive two or more portions of the DB log file in parallel from the host computing system through the two or more data transfer connections.

9. The system of claim 8, the DB log file comprising one or more of, a set of writes posted to the replicated DB, and a set of writes pending to the replicated DB.

10. The system of claim 9, the collection logic being configured to assemble the two or more portions of the DB log file into a single remote DB log file.

11. The system of claim 9, the collection logic being configured to selectively insert a received portion of a DB log file into a remote DB log file.

12. The system of claim 9, including a verification logic configured to determine whether a received portion of a DB log file has been received correctly.

13. The system of claim 13, the verification logic being configured to selectively request retransmission of a received portion of the DB log file from the host computing system.

14. A client-server computing system, comprising:
a server system comprising:
a server processor configured to run a server DBMS configured to manage a replicated DB, the server DBMS being configured to maintain a server DB log file associated with the replicated DB;
a server connection logic configured to establish the server side of two or more data transfer connections between the server computing system and a client computing system;
a partition logic configured to separate the server DB log file into two or more portions, the number of portions being determined, at least in part, by the number of data transfer connections established by the server connection logic; and
a distribution logic configured to provide the two or more portions in parallel to the client computing system through the two or more data transfer connections; and
a client computing system, comprising:
a client processor configured to run a client DBMS configured to maintain a replica DB, the client DBMS being configured to employ a client DB log file associated with a server DB log file to facilitate keeping the replica DB current with the replicated DB;
a client connection logic configured to establish the client side of the two or more data transfer connections; and
a collection logic configured to receive in parallel the two or more portions of the DB log file provided from the server computing system through the two or more data transfer connections.

15. A method, comprising
establishing two or more connections between a first computing system and a second computing system, the first computing system being configured to maintain a first copy of a database, the second computing system being configured to maintain a replica copy of the database;
partitioning a log file on the first computing system into two or more file parts based, at least in part, on the number of connections established between the first computing system and the second computing system; and
providing the two or more file parts from the first computing system to the second computing system substantially in parallel.

16. The method of claim 15, the log file comprising one or more of, a set of posted writes associated with the first copy of the database, and a set of pending writes associated with the first copy of the database.

17. The method of claim 16, including partitioning the log file into two or more unequal file parts based on one or more attributes of the two or more connections.

18. A computer-readable medium storing processor executable instructions operable to perform a method, the method comprising:
establishing two or more connections between a first computing system and a second computing system, the first computing system being configured to maintain a first copy of a database, the second computing system being configured to maintain a replica copy of the database;
partitioning a log file on the first computing system into two or more file parts based, at least in part, on the number of connections established between the first computing system and the second computing system; and
providing the two or more file parts from the first computing system to the second computing system substantially in parallel.

19. A method, comprising:
establishing two or more connections between a first computing system and a second computing system, the first computing system being configured to maintain a first copy of a database, the second computing system being configured to maintain a replica copy of the database;
receiving substantially in parallel in the second computing system from the first computing system two or more parts of a log file; and
selectively updating the replica copy of the database based on the two or more parts of the log file.

20. The method of claim 19, the log file comprising one or more of, a set of posted writes associated with the first copy of the database, and a set of pending writes associated with the first copy of the database.

21. A client-server method, comprising:
establishing two or more connections between a server computing system and a client computing system, the server computing system being configured to maintain a server copy of a database, the client computing system being configured to maintain a client copy of the server database;
partitioning a database log file on the server computing system into two or more file parts based, at least in part, on the number of connections established between the server computing system and the client computing system;
providing the two or more file parts from the server computing system to the client computing system substantially in parallel;
receiving substantially in parallel in the client computing system from the server computing system the two or more file parts; and
selectively updating the client copy of the server database based on the two or more file parts.

22. The client-server method of claim 21, the database log file comprising one or more of, a set of posted writes associated with the first copy of the database, and a set of pending writes associated with the first copy of the database.

23. A system, comprising:
means for partitioning a database file into N parts, N being an integer greater than one;
means for establishing M connections between a first computing system and a second computing system, M being an integer greater than one, the first computing system being configured to store an original copy of a database and the second computing system being configured to store a replica copy of the original copy of the database; and
means for transmitting, substantially in parallel, the N parts over the M connections.

24. A set of application programming interfaces embodied on a computer-readable medium for execution by a computer component in conjunction with maintaining a replica database using parallel log file transfers, comprising:
a first interface for communicating a database log identification data;
a second interface for communicating a degree of parallelism data;
a third interface for communicating a connection data; and
a fourth interface for communicating a database log partition data.
